(19) United States
(12) Patent Application Publication
(10) Pub. No.: US 2017/0113426 A1
(43) Pub. Date: Apr. 27, 2017

(54) SYSTEM AND METHOD FOR REPAIRING LEAKS IN IN-SERVICE UTILITY PIPELINES

(71) Applicant: Jeff MAINZER, Cary, IL (US)

(72) Inventor: Jeff MAINZER, Cary, IL (US)

(73) Assignee: Operations Technology Development, NFP, Des Plaines, IL (US)

(21) Appl. No.: 14/921,502

(22) Filed: Oct. 23, 2015

(51) Int. Cl. B29C 73/16

(52) U.S. Cl. CPC B29C 73/166; B29L 2023/22

(57) ABSTRACT

A method and system for repairing a leak in a utility pipeline. The system includes a mold that is attached to the utility pipeline in proximity to a leak. The method further includes injecting an adhesive and/or a sealant into the mold and allowing the adhesive or sealant to cure to form a cast sealing the leak in the utility pipeline.

### BACKGROUND OF THE INVENTION

Field of the Invention

This invention relates to a system and method for repairing leaks in in-service utility pipelines including natural gas pipelines. More specifically this invention relates to a mold that is positioned in proximity to a leak in a pipeline and injected with an adhesive to seal the leak.

Discussion of Related Art

Mechanical couplings and fittings, e.g., tees, valves, elbows, etc. are used widely throughout the natural gas industry in association with steel, cast iron, and plastic pipelines. Mechanical couplings and fittings generally all share a similar design in that rubber seals are compressed around pipes to be plumbed to create a seal. One disadvantage of this design is the lack of substantial axial (pullout) restraint for many of the coupling and fitting designs (types). After years of service, these couplings or fittings may develop a leak due to thermal expansion contraction of the pipeline, relaxation of the rubber seals, corrosion, or even gas composition changes. Indeed, recent failures of mechanical couplings have heightened concerns about their continued safety in natural gas distribution systems. Thus, it is desirable to have a means for remediating leaking mechanical couplings and fittings without having to remove the coupling or shut down the pipeline. It is also highly desirable to have the option of adding axial restraint at the same time. It will be appreciated that the ability to perform a repair without removing the coupling or fitting, without shutting down the pipeline, and without using bypass or cut-out methods for maintaining fluid flow would both save time and reduce costs associated with shutting down the pipeline.

Numerous methods for sealing connecting pipe sections and leaks are taught in the prior art. See U.S. Pat. No. 6,276,726 which teaches a pipe clamp closing over a leak; U.S. Pat. No. 5,372,391 which teaches an internal pipe attachment mechanism which employs a sealing assembly that is set by crushing the sealing assembly through setting of the mechanical connection between pipe sections; U.S. Pat. No. 4,713,870 which teaches insertion of an expandable sleeve into a pipe and expanding the sleeve against the pipe wall containing the leak to cover and, thus, seal the leak; and U.S. Pat. No. 4,652,023 which teaches a repair coupling employing a sealing liner having circumferential ribs which seal against the pipe wall on both sides of the leak to effectively isolate the leak. While all of these sealing methods address the problem of repairing a leak in a pipe, none of the methods results in a permanent plugging of the leak.

U.S. Pat. No. 8,296,915 teaches another method for repairing an in-service fluid conduit. The method of this patent uses a flexible fluid venting device that is attached to the pipe around the pipe leak. A composite repair material is applied to the fluid venting device and allowed to cure. However, this method does not repair all types of leaks, does not teach a rigid mold and does not disclose a step of pressurizing the composite repair material at the repair site.

### SUMMARY OF THE INVENTION

The invention is directed to a system and method for repairing utility pipelines while the pipeline remains in service, for example natural gas pipelines and other similar pipelines. Alternatively, the system and method of this invention may be used to repair other types of fluid containment vessels.

The system of this invention includes a mold to encapsulate a leak in the pipeline and an injected adhesive. The mold preferably includes an injection port for injecting the adhesive and a venting port to allow for the release of leaking fluids and/or gases. The mold is preferably manufactured of metal or other rigid and durable materials which are able to withstand pressure of the injected adhesive. In a preferred embodiment, the mold is sized and shaped to accommodate a specific pipe and/or pipe component shape, for example sized to fit around a specific pipe diameter of a straight section of pipe. The mold may also be designed to accommodate specific issues related to a specific type of leak, such as leaks around threaded fittings, leaks with surface corrosion around the leak, and/or a leak near a coupling. The molds preferably further include an o-ring or another type of gasket for forming a tight seal between the mold and the pipe and/or mold halves. After the adhesive cures to from a cast sealing the leak, the molds may be removed or remain attached to the pipe.

The method of this invention preferably includes a step of attaching the mold to the pipe to create a mold cavity defined by an interior surface of the mold and an outer surface of the pipe. The mold should at least partially surround a leak to be repaired, with at least the venting port providing a release for gas or fluid, for example natural gas, to escape the mold and the pipe. With the mold attached to the pipe and surrounding the leak, the method of this invention further includes injecting an adhesive into the injection port into the mold cavity. In an alternative embodiment, the adhesive may be replaced with or combined with another sealant such as, but not limited to, polyurethane, polyureas, polyester resins, vinyl ester resins, epoxy resins, butyl rubber, latex, silicone, and combinations thereof. The injected adhesive is preferably pushed into the mold cavity with a gas propellant, such as air or nitrogen. Once the mold cavity is filled with adhesive, the venting port is closed and the injected adhesive is pressurized to a pressure greater than an internal pressure of the pipe. Thereafter, the adhesive is allowed to cure sealing the leak in the pipe. After curing, the injection port and the venting port are preferably removed. If the mold is re-useable, the mold may also be removed. Alternatively, the mold may remain attached to the pipe to provide additional support to the repaired pipe. In an embodiment of this invention, the repaired pipe may also be wrapped with a commercially available pipe wrap material for added support and protection.

The system of this invention may further include a sleeve positioned on the leak prior to the attachment of the mold and adhesive. The sleeve providing additional strength and support to the repaired pipe. The sleeve may comprise fiber glass, carbon fiber, polymer fiber and other types of compression wraps.

### BRIEF DESCRIPTION OF THE DRAWINGS

These and other objects and features of this invention will be better understood from the following detailed description taken in conjunction with the drawings, wherein:

FIG. 1 shows a mold for repairing leaking pipes according to an embodiment of this invention.

FIG. 2 shows a section of pipe with a half of the mold shown in FIG. 1 attached.

FIG. 3 show the section of pipe with both halves of the mold shown in FIG. 1 attached.

FIG. 4 is a cross-sectional view of the mold shown in FIG. 1 attached to a pipe.

FIG. 5 shows the section of pipe repaired with the method of this invention.

FIG. 6 shows a mold for repairing leaking pipes according to another embodiment of this invention.

FIG. 7a shows a schematic drawing of the mold shown in FIG. 6.

FIG. 7b shows a schematic drawing of the mold half of the mold shown in FIG. 6.

FIG. 7c shows a schematic drawing of the other mold half of the mold shown in FIG. 6.

FIG. 8 shows the system for repairing leaking pipes according to an embodiment of this invention.

FIG. 9 shows a pipe repaired with an embodiment of this invention.

### DETAILED DESCRIPTION OF THE INVENTION

This invention is directed to a system and method for repairing leaks in in-service utility pipelines, for example natural gas pipelines, or other fluid containment vessels, without having to interrupt or shutdown the pipeline. In addition, the method of this invention enables the repair of a leak in a natural gas pipeline without having to install some form of bypass means to divert the natural gas around the leaking section of the pipeline to maintain the flow of natural gas in order to repair the leak. In addition to “in-service” fluid containment vessels, the method of this invention may also be applied to a pressurized fluid container having a leak through which the fluid within the container exits the container. Finally, the method of this invention may even be applied to a fluid containment vessel having an opening through which a fluid could leak but does not actually leak, such as where the internal fluid containment vessel pressure and the external fluid containment vessel pressure are in equilibrium.

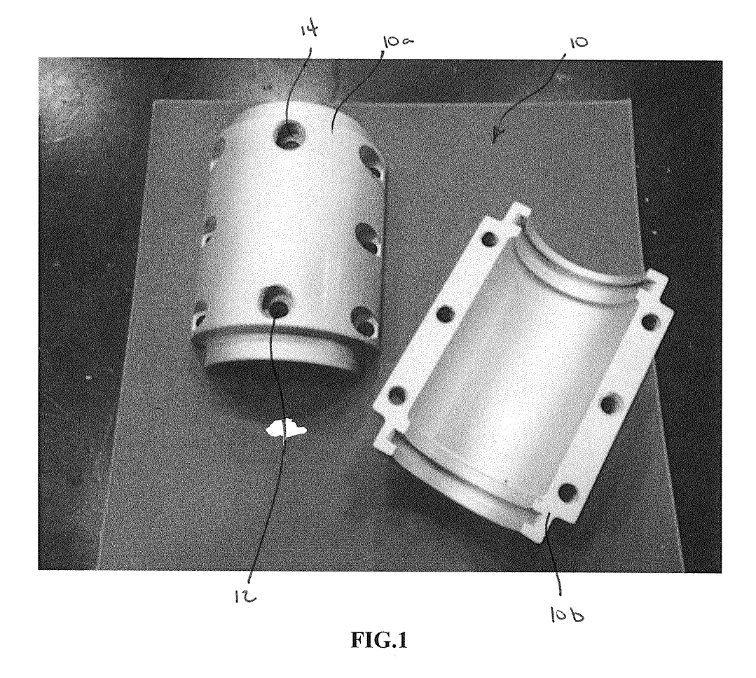

As shown in the embodiment of FIGS. 1-4, the system of this invention includes a mold 10 which is attached to a pipe 100 in fluid communication with a leak. In a preferred embodiment, the mold 10 includes an injection port 12 and a vent port 14. The mold 10 is preferably manufactured of metal or other rigid and durable materials able to withstand pressure of an injected adhesive. As best shown in FIG. 1, the mold 10 of this embodiment comprises two mold halves 10a, 10b which are mated together to form a tubular shape to fit around a straight section of pipe 100. The mold halves 10a, 10b are preferably mated with a gasket in-between faces of the mold halves 10a, 10b to provide a tight seal. In alternative embodiments of this invention, the mold may comprise another shape to accommodate another type of piping component, for example, but not limited to, a coupling, a valve, an elbow joint or a T-joint. The mold may also be shaped to accommodate a specific type of leak, for example, a corrosion leak or a pipe thread leak.

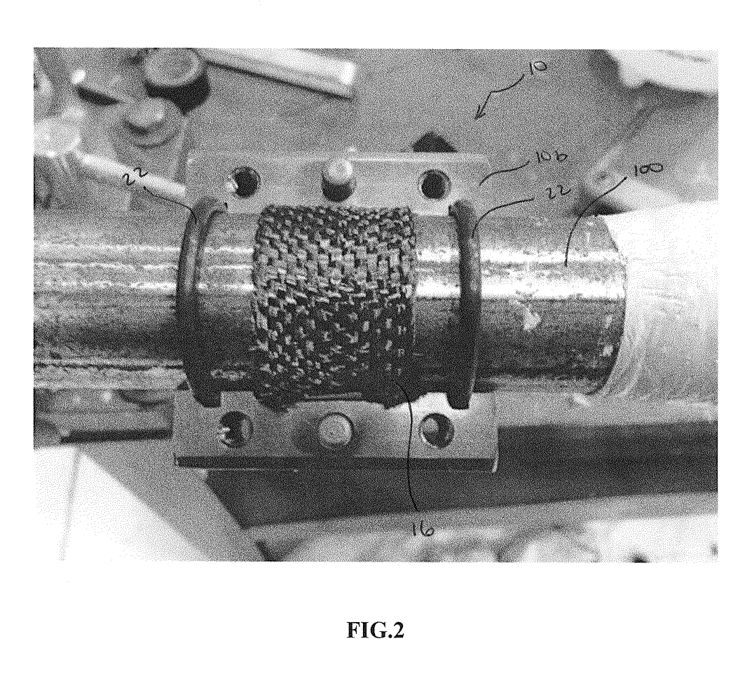

FIG. 2 shows one half of the mold 10b attached to the pipe 100. In this embodiment, the system of this invention further includes a gasket 22 positioned within a slot in the mold 10b to provide a tight seal between the mold 10 and the pipe 100. In this embodiment, the gasket 22 comprises an o-ring, however the system of this invention may include any type of gasket useful for creating a tight seal. The system shown in FIG. 2, further includes a sleeve 16 positioned on the leak to provide additional strength and support to a repaired pipe. The sleeve 16 may comprise fiber glass, carbon fiber, polymer fiber and other types of compression wraps. In alternative embodiments of this invention, the system may not include the gasket 22 and/or the sleeve 16.

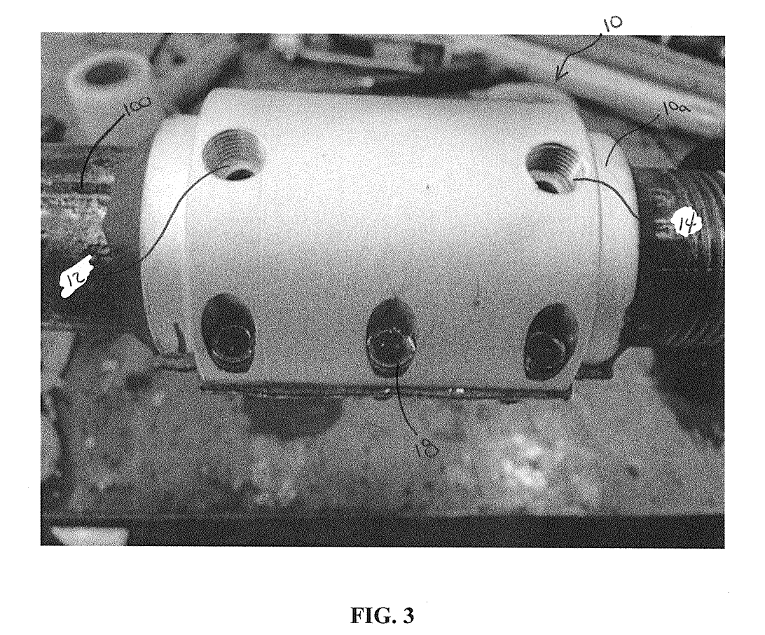

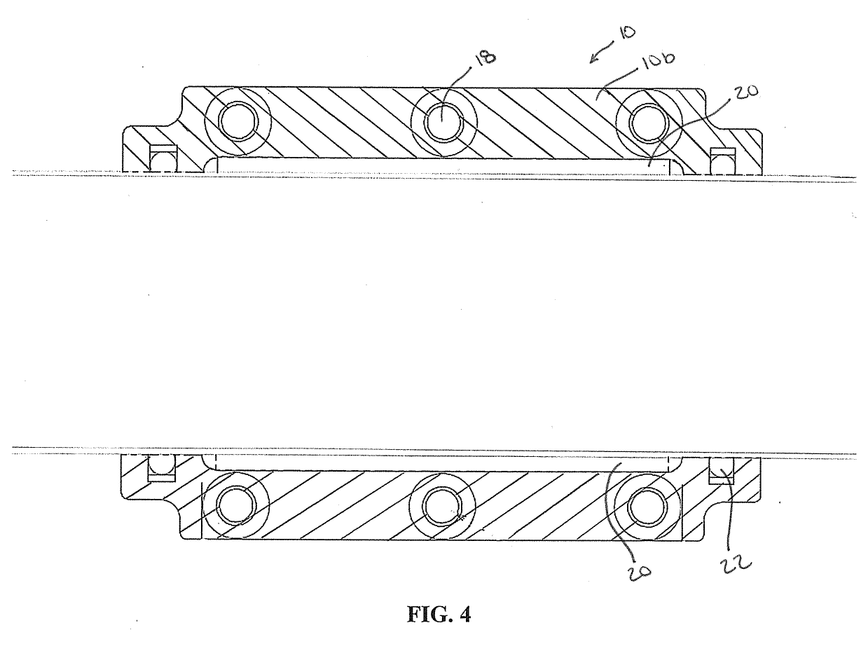

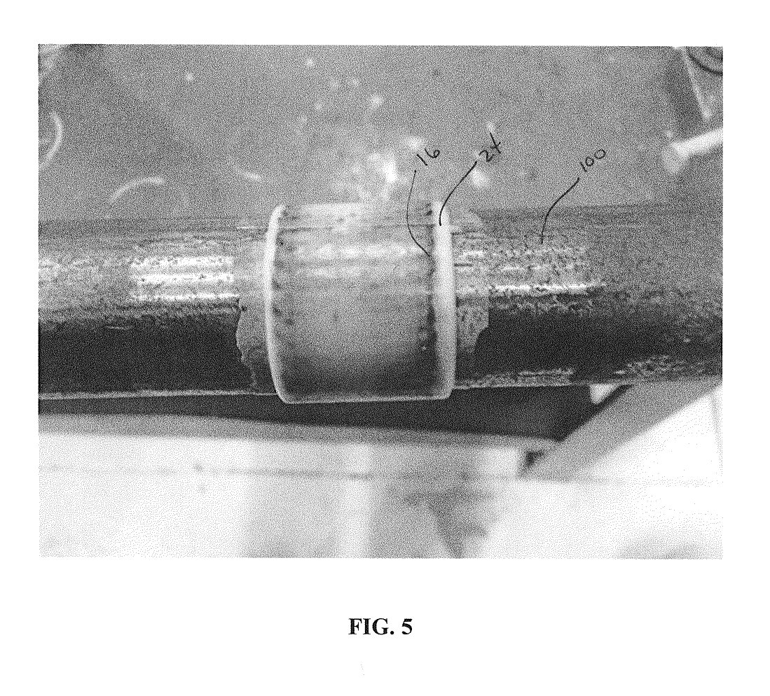

FIG. 3 shows the mold 10 halves 10a, 10b attached around the pipe 100 and connected together with a plurality of fasteners 18. In a preferred embodiment, a gasket or sealant is positioned between mating surfaces of the mold halves 10a, 10b to form a tight seal. As shown in the cross-sectional view of FIG. 4, the mold halves 10a, 10b create a mold cavity 20 defined by the mold 10 and an outer surface of the pipe 100. Please note that in FIG. 4, the sleeve 16 was removed for clarity. The mold 10 is preferably positioned to surround a leak to be repaired with the vent port 14 providing a release for the gas leaking from the pipe 100, allowing the gas to escape the mold 10 and the pipe 100. With the mold 10 attached to the pipe 100 and surrounding the leak, the method of this invention further includes injecting an adhesive 24 into the injection port 12 into the mold cavity 20. In an alternative embodiment, the adhesive 24 may be replaced with another sealant including, but not limited to, polyurethane, polyureas, polyester resins, vinyl ester resins, epoxy resins, butyl rubber, latex, silicone, and combinations thereof. The injected adhesive 24 is preferably pushed into the mold cavity with a gas, such as air or nitrogen. Once the mold cavity 20 is filled with the adhesive 24, the vent port 14 is closed and the injected adhesive 24 is pressurized to a pressure greater than an internal pressure of the pipe. Thereafter, the adhesive 24 is allowed to cure. After curing, the injection port 12 and the vent port 14 are removed. If the mold 10 is re-useable or disposable, the mold 10 is also removed. Alternatively, the mold 10 may remain attached to the pipe 100 to provide additional support to the repaired pipe. FIG. 5 shows the repaired pipe 100 with the adhesive 24 cured as a cast and the mold 10 removed. In another embodiment of this invention, the repaired pipe 100 may also be wrapped with a commercially available pipe wrap material for added support and protection.

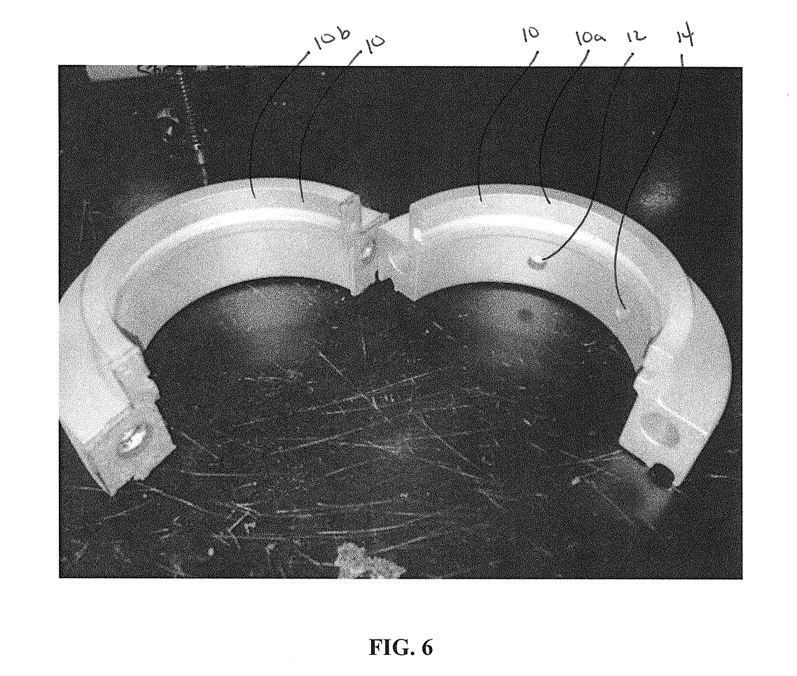

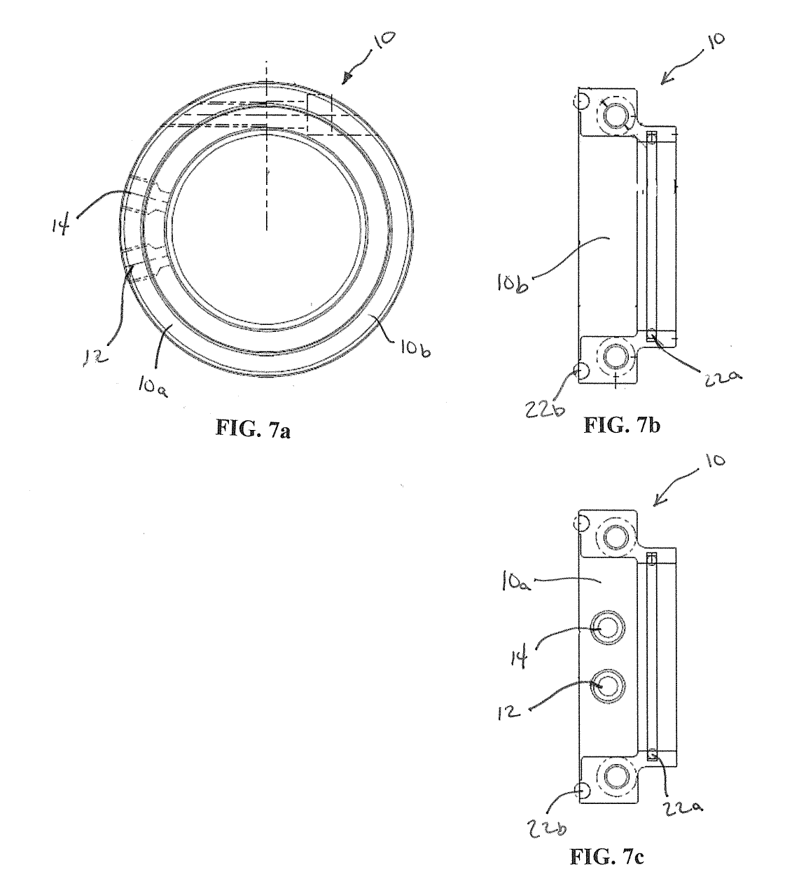

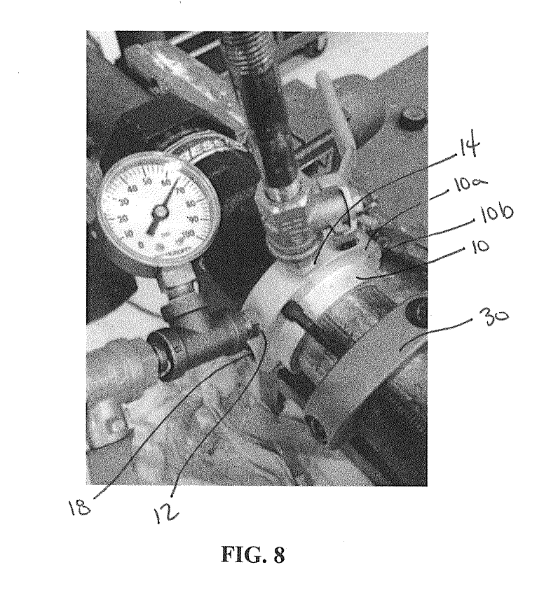

FIGS. 6-7c show another embodiment of the mold 10 of this invention. In this embodiment, the mold 10 is designed for repairing a leak between a pipe 100 and a coupling 200. As best shown in FIGS. 7a-7c, the mold 10 of this embodiment comprises two mold halves 10a, 10b which are mated together to form an annular shape to abut the coupling 200 on the pipe 100. As shown in FIG. 8, the mold 10 is preferably secured in position next to the coupling 200 with an axial restraint 30.

In a preferred embodiment of this invention, as shown in FIGS. 7b and 7c, the mold 10 includes a pair of gaskets 22a, 22b to create a tight seal. One of the gaskets 22a is an o-ring positioned between the mold 10 and the pipe 100 and the other gasket 22b is an o-ring positioned between the mold 10 and a face of the coupling 200.

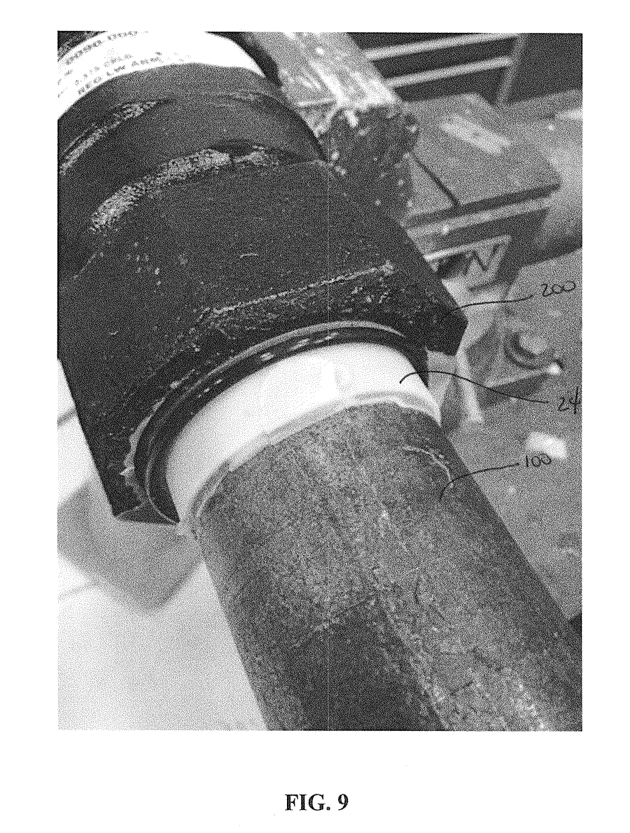

As shown in FIG. 8, the mold halves 10a, 10b are attached around the pipe 100 and connected together with a plurality of fasteners 18. The mold halves 10a, 10b create the mold cavity 20 defined by the mold 10, the face of the coupling 200, and the outer surface of the pipe 100. The mold 10 is preferably positioned to surround the leak to be repaired with the vent port 14 providing release for the gas leaking from the coupling 200 and/or the pipe 100, allowing the gas to escape the mold 10. With the mold 10 attached and surrounding the leak, the method of this invention further includes injecting an adhesive 24 into the injection port 12 into the mold cavity 20. Once the mold cavity 20 is filled with the adhesive 24, the vent port 14 is closed and the injected adhesive 24 is pressurized to a pressure greater than an internal pressure of the pipe. Thereafter, the adhesive 24 is allowed to cure forming a cast to repair the leak. It should be understood that the curing time for the adhesive and/or sealant will vary depending upon the material used. The adhesive and/or sealant may be allowed to cure naturally or curing may be accelerated or improved by heating or other known processes. After curing, the injection port 12 and the vent port 14 are removed. If the mold 10 is re-useable or disposable, the mold 10 is also removed. Alternatively, the mold 10 may remain attached to the pipe 100 to provide additional support to the repaired pipe. FIG. 9 shows the repaired pipe 100 and coupling 200 with the cured adhesive 24. In another embodiment of this invention, the repair may also be wrapped with a commercially available pipe wrap material for added support and protection.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method for repairing a pipeline comprising:
attaching a mold to the pipeline in proximity to a leak in the pipeline, wherein the mold includes an injection port and a vent port;
injecting an adhesive into the injection port to fill a mold cavity between the mold and a surface of the pipe;
venting the volume through the vent port until the volume is filled with adhesive;
closing the vent port after the volume is filled with adhesive;
pressurizing the adhesive in the mold cavity; and
curing the adhesive.

2. The method of claim 1, wherein the injection port and vent port are removed from the mold after the adhesive has cured.

3. The method of claim 1, wherein the mold is removed from the pipeline after the adhesive has cured.

4. The method of claim 1, further comprising a step of:
wrapping the adhesive in a pipe wrap material.

5. The method of claim 1, further comprising a step of:
applying sleeve to the pipe prior to attaching the mold to the pipeline.

6. The method of claim 1, wherein the step of injecting the adhesive includes a gas propellant.

7. The method of claim 6, wherein the gas comprises nitrogen.

8. The method of claim 1, wherein the mold is secured in position with an axial restraint.

9. The method of claim 1, wherein the mold includes a gasket positioned between a mold face and the pipeline to provide a seal between the mold and the pipeline.

10. A method for repairing a pipeline comprising:
attaching a mold to the pipeline to cover a leak in the pipeline, wherein the mold includes an injection port and a vent port and wherein the vent port provides an outlet for a gas leaking from the pipeline;
injecting a sealant into the injection port to fill a mold cavity between the mold and a surface of the pipeline;
closing the vent port after the volume is filled with the sealant;
pressurizing the mold cavity with the sealant; and
curing the sealant.

11. The method of claim 10, wherein the sealant comprises at least one of adhesive, polyurethane, polyureas, polyester resins, vinyl ester resins, epoxy resins, butyl rubber, latex, and silicone.

12. The method of claim 10, wherein the mold is removed from the pipeline after the adhesive has cured.

13. The method of claim 10, further comprising a step of:
wrapping the cured adhesive in a pipe wrap material.

14. The method of claim 10, further comprising a step of:
applying sleeve to the pipe prior to attaching the mold to the pipeline, wherein the sleeve comprises at least one of fiber glass, carbon fiber, and polymer fiber.

15. The method of claim 10, wherein the step of injecting the sealant includes a gas propellant.

16. The method of claim 10, wherein the mold is secured in position with an axial restraint.

17. The method of claim 10, wherein the mold includes a gasket positioned between a mold face and the pipeline to provide a seal between the mold and the pipeline.
